(19) United States
(12) Patent Application Publication
(10) Pub. No.: US 2024/0326694 A1
(43) Pub. Date: Oct. 3, 2024

(54) ADAPTIVE SENSING FOR IMPROVED SAFETY IN COMMERCIAL VEHICLE OPERATIONS

(71) Applicant: VIA Technologies, Inc., Taipei (TW)

(72) Inventors: Benjamin Yarming Pan, Taipei (TW); Chaochin CHANG, Taipei (TW); Chohan WU, Taipei (TW)

(21) Appl. No.: 18/532,002

(22) Filed: Dec. 7, 2023

Related U.S. Application Data
(60) Provisional application No. 63/493,323, filed on Mar. 31, 2023.

(51) Int. Cl. B60R 1/22; B60W 50/00; B60W 50/14; G01S 7/40; G01S 13/931

(52) U.S. Cl. CPC B60R 1/22; B60W 50/0097; B60W 50/14; G01S 7/40; G01S 13/931; B60R 2300/202; B60R 2300/802; B60W 2050/0083; B60W 2050/146; B60W 2300/12; B60W 2420/403; B60W 2420/408; G01S 2013/9315

(57) ABSTRACT

In one embodiment, a blind spot detection system for a vehicle, the system comprising: one or more sensors configured to detect vehicle movements; a memory comprising instructions; and a controller configured by the instructions to: predict an impending sharp turn of the vehicle based on receiving a signal or signals from the one or more sensors; adjust a detection range from a first setting based on the prediction; and return to the first setting of the detection range upon termination of a sharp turn by the vehicle.

### CROSS REFERENCE TO RELATED APPLICATION

This application claims the benefit of U.S. Provisional Application No. 63/493,323 filed Mar. 31, 2023, which is hereby incorporated by reference in its entirety.

### TECHNICAL FIELD

The present disclosure is generally related to road vehicles with large blind spots, and, in particular, safety features in large road vehicles.

### BACKGROUND

Road vehicles of many types have traditionally imposed certain challenges to operators in enabling clear views of the surrounding areas and objects within those areas. For instance, the structure and shape of vehicles and windshield/windows typically imposes an obstruction for a driver with respect to the turning side field of view. The obstruction in the field of view is often referred to as a blind spot, and its location and/or scope (e.g., in area and/or distance from the vehicle) may vary depending on the size of the vehicle. In vehicles with large blind spots, such as large vehicles and especially large commercial vehicles such as tractor trailers, placards are often placed on the trailer warning trailing vehicles that the inability by the driver of a trailing vehicle to see a reflection of the driver of the tractor in the rear view mirror of the tractor means that the driver of the tractor is unable to see the trailing vehicle because the trailing vehicle is in the tractor-trailer blind spot. In some commercial vehicles, for instance those involved in commercial excavation sites such as large haul or dump trucks, the blind spot area is much more extensive than the blind spot area for smaller, passenger vehicles, particularly when making hard or sharp turns. The blind spot issue is not limited to large commercial vehicles, though, as operators of large recreational vehicles may face similar challenges.

When maneuvering the vehicle into turns, there is a risk of personal injury and/or damage to all proximally located vehicles, property, or people (hereinafter, objects) in a blind spot intersected by the path or trajectory of the large vehicle. What is needed is a way to detect the presence of objects that are located within the blind spot of the large vehicle while also alerting the driver of the large vehicle of the presence of the vehicle in the blind spot with sufficient time to avoid collision.

### SUMMARY

In one embodiment, a blind spot detection system for a vehicle, the system comprising: one or more sensors configured to detect vehicle movements; a memory comprising instructions; and a controller configured by the instructions to: predict an impending sharp turn of the vehicle based on receiving a signal or signals from the one or more sensors; adjust a detection range from a first setting based on the prediction; and return to the first setting of the detection range upon termination of a sharp turn by the vehicle.

Other systems, methods, features, and advantages of the present invention will be or become apparent to one with skill in the art upon examination of the following drawings and detailed description. It is intended that such additional systems, methods, features, and advantages be included within this description, be within the scope of the present invention, and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a schematic diagram that illustrates in plan, overhead view different detection zones.

FIG. 2 is a schematic diagram that illustrates an example sharp turn that poses less of a risk of collision between vehicles because of the down-road vehicle distance away from the turn.

FIG. 3 is a schematic diagram that illustrates an example sharp turn that poses a greater risk of collision between vehicles because of the proximity of the down-road vehicle to the turn.

FIG. 4 is a schematic diagram that illustrates an example extended detection zone for a vehicle for right turns for an embodiment of a blind spot detection system.

FIG. 5 is a schematic diagram that illustrates example distances for prediction of a sharp turn and an example extended detection zone for a vehicle as determined by an embodiment of a blind spot detection system.

FIG. 6 is a state diagram that illustrates an example sharp turn state machine implemented by an embodiment of a blind spot detection system.

FIG. 7A is an example screen diagram that illustrates an example camera view of an extended detection zone for a vehicle and detection of an obstruction at the right side of the vehicle for a right sharp turn for an embodiment of a blind spot detection system.

FIG. 7B is an example screen diagram that illustrates an example camera view of an extended detection zone for a vehicle and detection of an obstruction at the left side of the vehicle for a left sharp turn for an embodiment of a blind spot detection system.

FIG. 8 is a schematic diagram that illustrates an embodiment of an example controller and associated components used in an embodiment of a blind spot detection system.

FIG. 9 is a flow diagram that illustrates an embodiment of an example blind spot detection method.

### DESCRIPTION OF EXAMPLE EMBODIMENTS

Certain embodiments of a blind spot detection system and method are disclosed that uses adaptive sensing to boost the safety and maneuverability of large vehicles, or more generally, vehicles with large blind spots, by predicting an impending sharp turn and assisting an operator (e.g., driver) with increased visibility or reduced blind spot, and early warning to avoid a collision with objects located within the blind spot while in the sharp turn. In one embodiment, the blind spot detection system uses sensor input (e.g., location and/or inertial sensors) to predict whether the vehicle is about to negotiate a sharp turn, and accordingly, adjusts a detection range relative to a first setting (e.g., detection settings used during relatively straight driving or wide but not sharp turns) based on the prediction for detection of objects during the sharp turn maneuver. The adjusted-to setting, or second setting, comprises an extended protection zone or range that includes extending detection at the turning side of the vehicle. Upon the vehicle ceasing the sharp turn (e.g., returning to a wide turn, proceeding in a straight path, or stopping), the blind spot detection system returns from the extended protection zone setting to the first setting of the detection range while continuously monitoring the sensor input to anticipate and respond to any subsequent sharp turns.

Digressing briefly, large vehicles (e.g., mining or hauling trucks, at weights of approximately 26,000 pounds or more) possess a larger blind spot than smaller vehicles (e.g., passenger sedans, small pickup trucks, etc.), and particularly during sharp turning maneuvers, risk collision with other vehicles (or generally, objects) that are undetected (e.g., in the blind spot) by the operator. Large vehicles, given their weight, also require a longer distance to stop than smaller vehicles. Technology, such as radar, helps to effectively reduce this blind spot (e.g., expand detection), but depending on the surrounding terrain, may provide false alerts, such as from boulders or other objects not on a collision course with the vehicle. In contrast, certain embodiments of a blind spot detection system use location and/or inertial sensors and knowledge-base/heuristics (e.g., gathering a large quantity of raw data and developing rules) to predict a sharp turn (also referred to as a hard turn) and extend the detection range on the turning side (and in some embodiments, forward and rearward of) the vehicle during the sharp turn, mitigating the risk of collision due to an effectively reduced blind spot and expanded sensing for enabling timely alerts to the operator.

Having summarized certain features of a blind spot detection system of the present disclosure, reference will now be made in detail to the description of a blind spot detection system as illustrated in the drawings. While a blind spot detection system will be described in connection with these drawings, there is no intent to limit it to the embodiment or embodiments disclosed herein. For instance, in the description that follows, there is an emphasis on large commercial vehicles, including a hauler used as an illustrative example, though other types of large commercial vehicles may be used. Further, the blind spot detection system may be used in other types of vehicles, including large non-commercial vehicles (e.g., recreational vehicles), which may also have a larger blind spot than smaller, passenger vehicles. The vehicle described herein may utilize any one of a plurality of different existing steering systems, including the typical hydraulic steering gear, (powered) rack and pinion steering mechanisms, a steer-by-wire steering system that uses a joystick or steering wheel as the operator interface, etc. Since emphasis herein is not on the type or control of steering, as such systems exist today, description of the same herein is omitted to avoid obfuscating the focus of the disclosure. Further, though the vehicles described herein are generally equipped with a cab in which an operator controls the vehicle, in some embodiments, the vehicle may be operated with or without an operator in the cab in an autonomous, semi-autonomous, or remote-control manner in which cameras are used in place of, or as a supplement to, proximal and direct vehicle operational control (e.g., where the operator sits in the cab and controls the steering wheel, accelerator pedals, brakes, etc.). Further, although the description identifies or describes specifics of one or more embodiments, such specifics are not necessarily part of every embodiment, nor are all various stated advantages necessarily associated with a single embodiment or all embodiments. On the contrary, the intent is to cover alternatives, modifications and equivalents included within the scope of the invention as defined by the appended claims. Further, it should be appreciated in the context of the present disclosure that the claims are not necessarily limited to the particular embodiments set out in the description.

Note that reference herein to steering or steering control is to be understood as steering control characterized primarily by direct operator intervention, as opposed to what may be characterized primarily as machine or satellite guided control, though as explained above, some embodiments may use autonomous or semi-autonomous control of the vehicle proximal to, or remote from, the vehicle and benefit from a blind spot detection system as described herein.

Note also that references hereinafter made to certain directions, such as, for example, “front”, “rear”, “left” and “right”, are made as viewed from the rear of a vehicle looking forwardly.

Additionally, a sharp or hard turn is distinguished from one that is not based on, for instance, the speed of the vehicle and turning angle. For instance, a vehicle may turn in a complete circle, where the turn in a span of one minute may not rise to a level of force (e.g., acceleration or centripetal force) to be characterized as a sharp or hard turn than the same turn in, say, five seconds. As another example, at a given speed, a vehicle turning may experience greater force at an angle of eighty (80) degrees than the same vehicle at an angle of one hundred, twenty (120) degrees. A hairpin turn may qualify as a sharp turn based on the speed at which the vehicle travels. Additionally, a vehicle moving quickly through a turn poses a greater risk of collision than one moving slowly through the turn, since a driver requires a quicker time to react and the vehicle needs more time to stop or more distance to stop. The decision as to what qualifies as a sharp turn or a fast turn may be based on analysis of data for any given application and vehicle or vehicle type, as explained further below.

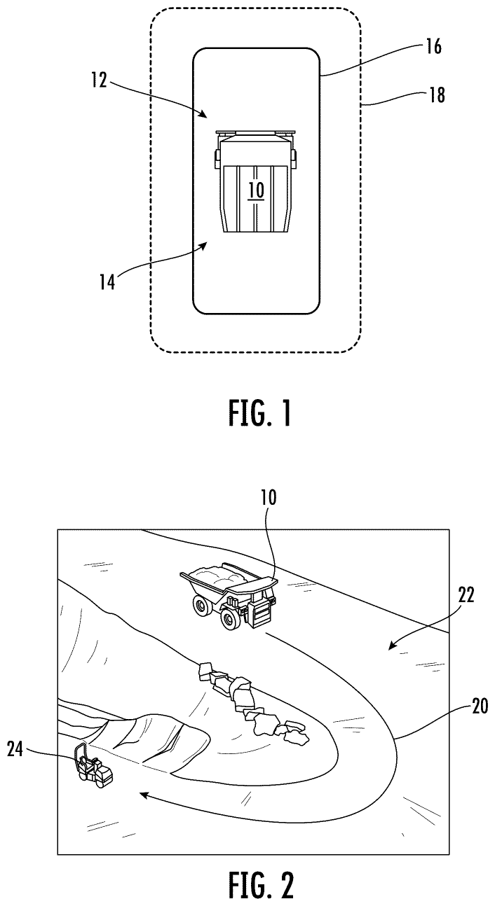

Referring now to FIG. 1, shown are different example detection zones for a vehicle. In particular, an overhead plan view of a vehicle 10 is shown, with the front 12 and rear 14 of the vehicle as shown (e.g., from top to bottom in a portrait view of the page). A first zone 16 is shown bounded by an inner rectangle surrounding the vehicle 10. The first zone 16 corresponds to a detection zone as directly observable by an operator within the vehicle 10. A second zone 18 is shown bounded by a rectangle offset a distance from and surrounding the inner rectangle. The second zone 18 may correspond to a detection zone as sensed using existing sensors (e.g., radar sensors, camera sensors, etc.) and corresponding software (e.g., image recognition, radar processing, etc.), and overlaps in part with the first zone 16. The second zone 18 (and beyond) includes a blind spot for the operator, yet the sensors enable detection in this blind spot. Technology can be said to effectively reduce the blind spot by enabling the user to detect objects located within that area (though such areas are undetectable visually by the operator, when unaided by technology, and still referred to as a blind spot). Areas extending outside of and including the first zone 16 and second zone 18, correspond to an extended detection zone as implemented by an embodiment of a blind spot detection system, as described further below. Though the detection zones 16 and 18 are shown with rectangular boundaries, other geometric shapes for the range or zone boundaries (e.g., ovals) may be used and hence are contemplated to be within the scope of the invention. Note that reference herein to blind spot generally refers to any area of poor visibility around the vehicle, and includes an area adjacent a vehicle on a turning side of the vehicle where objects are undetectable or difficult to detect by the operator unaided by technology, or the detection is not trustworthy/reliable.

FIG. 2 is a schematic diagram that illustrates an example sharp turn that poses less of a risk of collision between the vehicle 10 and other objects (e.g., another vehicle) because of the down-road vehicle distance away from the turn. As shown, FIG. 2 illustrates the example vehicle 10 (e.g., of FIG. 1) and a pathway that involves negotiating (e.g., steering through) a sharp turn that is to be predicted and detected by an embodiment of a blind spot detection system. The vehicle 10 is illustrated as a hauler, though as explained above, may be embodied as other types of large vehicles or a vehicle with large blind spots. The vehicle 10 is shown traveling along a trajectory, represented by curved line 20 that follows a road 22 upon which the vehicle 10 is traveling, and which further illustrates the need for the vehicle 10 to negotiate a sharp turn to continue safely travelling along the road 22. An object 24 (e.g., a vehicle, though may be other objects such as an animal, human being, inanimate, etc.) is shown on the road 22, the object 24 located down-road from the moving vehicle 10. If the trajectory represented by the curved line 20 continued toward the object 24, the risk of collision is minimal, since the object 24 is within the line-of-sight of the operator of the vehicle 10. That is, the vehicle 10 would have departed from the turn and been travelling in a straight line before reaching the object 24, the object no longer in the blind spot of the vehicle 10. On the other hand, if the object 24 was at a location corresponding to the end of (or immediately preceding) the end of the curved line 20, the risk of collision between the object 24 and the vehicle 10 is greater given that the vehicle 10 is at or near the end of the turn.

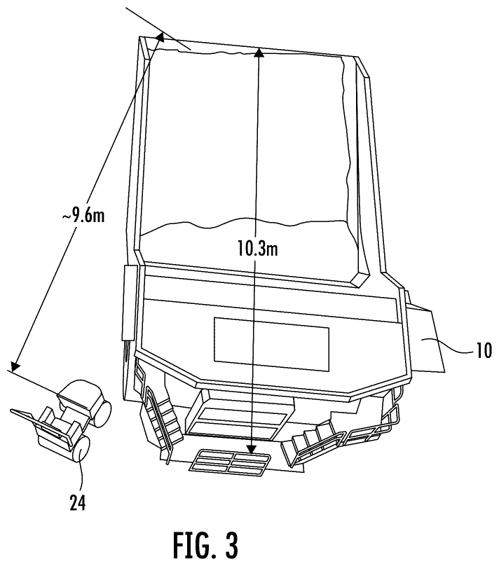

FIG. 3 is a schematic diagram that illustrates an example sharp turn that poses a greater risk of collision between the vehicle 10 and the object 24 because of the proximity of the down-road vehicle to the turn. Shown is the vehicle 10 negotiating the turn, and the object 24 closer to the turn (e.g., compared to the position of the object 24 shown in FIG. 2). Shown are also some example dimensions of the vehicle 10 relative to the object 24 (e.g., 10.3 meters in length) and angular dimension relative to a datum proximal to the rear of the hauler (e.g., 9.6 meters) while the vehicle 10 is in the turn. In this scenario, if the object 24 was detected according to the illustrated snapshot, it was too late for the vehicle 10 to avoid collision with the object 24 given the proximity of the vehicle 10 to the object 24 when detected, the size of the vehicle 10 (e.g., a larger vehicle takes longer to stop and is less maneuverable), and the reaction time of the operator. In some instances, the object 24 may not even be detected based on not being within the detection range during a turn (e.g., not detected by either the operator since not within the first zone 16 of FIG. 1, or by sensors corresponding to the second zone 18 of FIG. 1 since the objects 24 is in an area or range that is extended a distance from the side of the vehicle 10 (beyond the sensing range corresponding to the second zone 18). Certain embodiments of a blind spot detection system extend the detection zone beyond the existing zones 16 and 18 on at least the turning side of the vehicle 10, which enables detection in the blind spot present during a sharp turn not detected using existing techniques. Also, as described below, the blind spot detection system predicts the sharp turn, enabling a transition to the extended detection/protection zone before the vehicle 10 actually enters the turn. This latter feature enables detection of the object before the vehicle 10 has actually departed or recovered from the turn, enabling suitable reaction time by the operator to maneuver the vehicle 10 past the object 24 or to a stop.

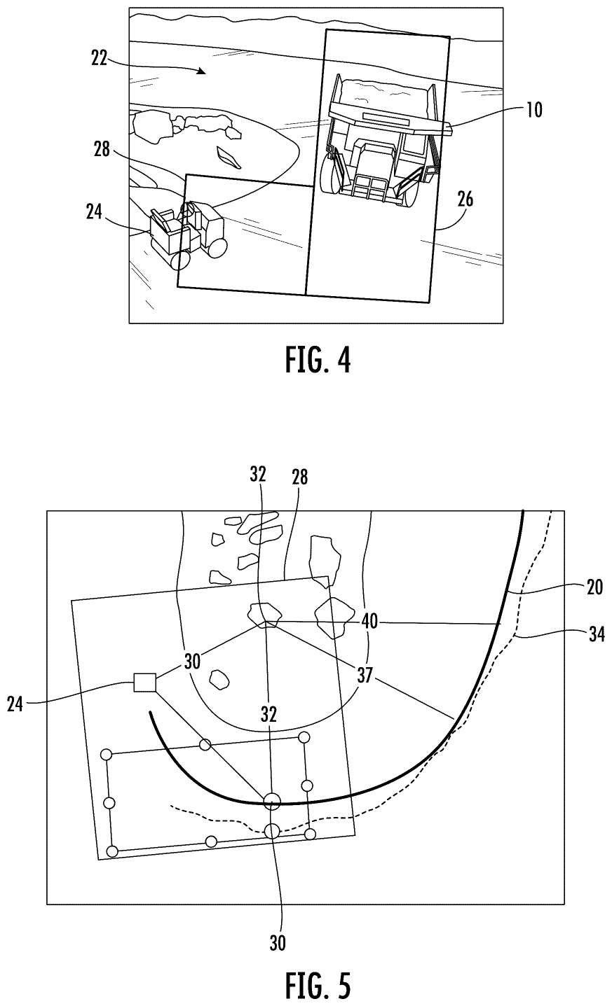

Explaining further, and referring now to FIG. 4, the vehicle 10 is shown beginning to enter a sharp turn while travelling on the road 22, and the object 24 potentially along its path. In one embodiment, the blind spot detection system of the vehicle 10 predicts the impending sharp turn based on a knowledge-base/heuristics approach (e.g., using a set of conditions and decisions or rules drawn from past analysis of data and based on sensor input), and adjusts the detection zone from a first setting to an extended (e.g., expanded) detection zone (also herein, referred to as an adjusted detection range) corresponding to a second setting, the extended detection zone used during the vehicle navigation of the sharp turn. Shown in FIG. 4 is an example detection zone 26 based on a first setting, the detection zone 26 based on a first setting also referred to herein as a base or initial detection zone 26. The detection zone 26 is similar to detection zone 18 (FIG. 1), and as explained above, may be of a different geometry and/or size in some embodiments. The detection zone 26 uses technology (e.g., sensors including camera and/or radar sensors and associated software) that extends the detection ability of the operator (e.g., effectively reducing the blind spot). Also shown in FIG. 4 is an extended detection zone 28, which is a result of an adjustment of the base detection zone 26 to extend detection on the turning side of the vehicle 10 based on the prediction of a sharp turn. Detection zones that are not extended detection zones 28 are also referred to herein as non-extended detection zone(s) or non-extended detection range(s). The extended detection zone 28 corresponds to a second (detection zone) setting different than the first setting. As noted in FIG. 4, the extended detection zone 28 enables the vehicle 10 to detect the object 24 in the road on the turning side of the vehicle 10 while the vehicle 10 is in the sharp turn, where without the extended detection, the object would be located in a blind spot of the vehicle 10 (and not within the detection zone 26 until perhaps it is too late to take collision avoidance measures). Notably, the detection zone 26 extends to the front of the vehicle 10, yet that range is insufficient to detect the object 24 an extended distance along the turning side of the vehicle 10 during a sharp or tight turn as illustrated in this example.

Certain embodiments of a blind spot detection system adjusts a detection range from that provided by the detection zone 26 to the extended detection zone 28, the latter which extends the range at least to the turning side of the vehicle 10. By extending the detection to the turning side of the vehicle 10, the object 24 is detectable during a sharp turn and, because of the prediction, within sufficient time for the operator (or collision avoidance technology within the vehicle 10) to avoid a collision with the object 24. Stated otherwise, the prediction mechanisms of the blind spot detection system enables an adjustment (extension, or the extended detection zone 28) in the detection range (e.g., from the first setting reflected by the detection zone 26) with sufficient time to deploy collision avoidance measures while in the sharp turn. It should be appreciated by one having ordinary skill in the art, in the context of the present disclosure, that the extended detection zone 28 may cover additional areas. For instance, though the extended detection zone 28 is shown in FIG. 4 to extend detection in front of, and to the turning side, of the vehicle 10, in some embodiments, the extended detection zone may also extend to areas forward and/or rearward of the vehicle 10 (e.g., extended adjacent the right hand side boundaries of the detection zone 26).

FIG. 5 illustrates some example dimensions for the extended detection zone 28 for an example roadway scenario (similar to those depicted in FIGS. 2-4). Shown in overhead view is the trajectory (curved line 20) of the vehicle, with the rear right tire of the vehicle depicted symbolically with reference number 30 (the lowest 30 in the figure, the upper 30 referring to a distance dimension). A reference point 32 (e.g., the top-most 32 in the figure, the lower 32 referring to a distance between the reference point 32 and the rear right tire reference 30) for determining the turning radius) is also shown. As noted from the trajectory, the vehicle 10 progresses along the trajectory represented by curved line 20 from forty feet (40 ft.) from the reference point 32 as it departs from the straight line path, followed by thirty-seven (37) ft., then thirty-two (32) ft. The angle between the 40 ft. line intersection of the trajectory and the 32 ft. line intersection is approximately ninety-degrees. As the vehicle is about to enter the latter half of what may be described as a hairpin turn (e.g., at approximately the ninety-degree point), an embodiment of the blind spot detection system predicts that the vehicle is entering a sharp turn. By doing so, the blind spot detection system activates the extended detection zone, enabling detection of the object 24 (represented as a square symbol in FIG. 5) at approximately 33 ft. (approximately 10 meter) from the vehicle. By predicting the sharp turn and activating the extended detection zone, the object 24 is detected during the turn with sufficient time to alert the operator and enable the operator to avoid collision. Note that these values are merely illustrative of a simple example.

In some embodiments, the blind spot detection system detects and enters the sharp turn at approximately eighty-degrees (80 degrees), and adjusts (e.g., extends) the detection range to approximately fifteen (15) meters (m) or approximately forty-nine (49) ft. in front of the vehicle 10 and 15 meters on the turning side of the vehicle 10. In one embodiment, detection of the object 24 may be achieved via camera sensor in conjunction with image processing (e.g., existing object detection/recognition software). In some embodiments, the detection of the object 24 may be achieved with the camera/software and also other sensing technology. For instance, radar technology (e.g., a radar sensor) may also be used, where the range of the radar sensor may be at or less than the range of the camera sensor (e.g., to avoid false alerts caused by detection of surrounding objects, such as boulders, trees, etc.). In some embodiments, the blind spot detection system may disable radar detection in the side (turning side) zone during a sharp turn to prevent false alerts (e.g., from boulders in the extended range). In some embodiments, one or more additional sensors may be used. In one embodiment, the blind spot detection system may also receive feedback of the steering wheel (or whatever navigating device the operator uses to control the movement of the vehicle) during the prediction and/or detection process. For instance, the direction in which the operator maneuvers the steering wheel may provide preliminary insight to the blind spot detection system as to whether the operator intends to straighten the vehicle or turn the vehicle (e.g., make a hard turn). Based on these example values, the blind spot detection system provides for an alert to the operator within one (1) second from the time of detection (e.g., assuming a built-in 0.3 second lag reaction time of the operator). If the speed of the vehicle is, say, five (5) miles per hour (MPH), the vehicle 10 has approximately 7.8 meters (approximately twenty-five (25) ft.) to come to a full stop.

It is noted that prediction of the sharp turn is performed during negotiation of the turn, and in one embodiment, before or at the time of entering the latter half of the turn (e.g., at approximately ninety-degrees), and not delayed until after the vehicle is already in the turn, to enable sufficient reaction time for detection and collision avoidance. In one embodiment, a threshold may be established for the turning angle that balances the need for sufficient reaction time while avoiding unnecessary activation of the extended detection range (e.g., for normal, ninety-degree (90 degree) turns). In one embodiment, the threshold is set at, or approximately at, seventy-degrees (70 degrees). In some embodiments, the threshold is set at, or approximately at, eighty-degrees (80 degrees). In some embodiments, the threshold is set at, or approximately at, ninety-degrees (90 degrees). In some embodiments, such as to account for a reduced approach angle, the threshold may be set at less than ninety-degrees (90 degrees). Note that the determination of threshold angle may also be set based on the approach angle. For instance, curved line 34 may correspond to a trajectory in which the operator maneuvers the vehicle along a wider angle of approach (e.g., hugging the left side of the road before entering the turn), which may alter the point in which a hard or sharp turn is predicted.

In some embodiments, filtering and timeout mechanisms may be used to eliminate and/or reduce the time spent in a sharp turn mode of operation.

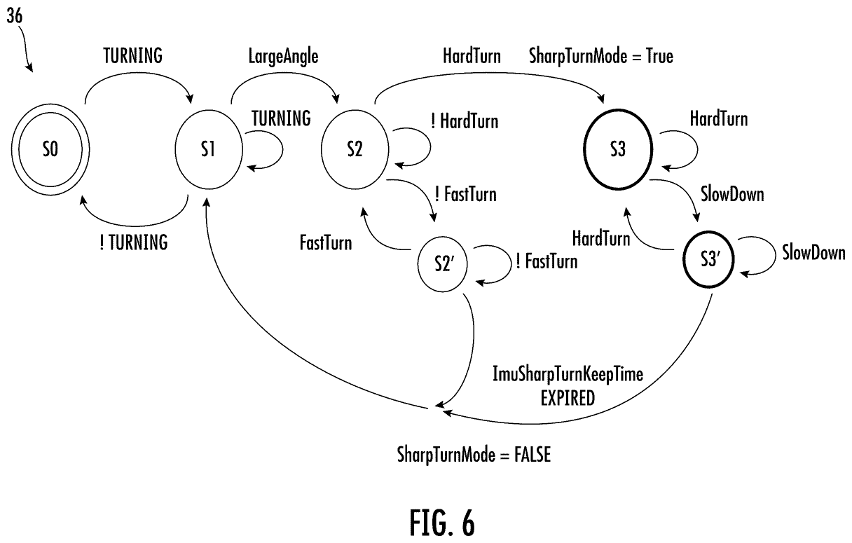

FIG. 6 is a state diagram 36 that illustrates an example sharp turn state machine implemented by an embodiment of a blind spot detection system. In some embodiments, the decision on whether or not the vehicle is in, or is about to enter, a sharp turn and when to extend the detection zone may be based on other decision mechanisms that do not rely on a state change, such as through the use of conditions/rules. Conceptually, the prediction as to whether the vehicle is about to enter a sharp turn and the deployment of an extended detection zone may be considered as decisions of inclusion and exclusion, whereby a determination is made whether vehicle movement meets a first condition(s) (e.g., includes a large angle), and then a determination is made to exclude turns that are not sharp. Referring to the state diagram 36, states include S0 (normal forward), S1 (turning mode), S2 (large-turn mode), S2′ (large-turn keep mode), S3 (sharp-turn mode), and S3′ (sharp-turn keep mode). The S1′ and S2′ modes are monitoring or watching states to determine whether there is a change in state from S2 and S3, respectively. The state machine depicted by state diagram 36 shows state transitions between normal forward travel (S0) and turns (S1), the latter progressing to a plurality of different states based on determinations from sensor input. The states S0 and S1 correspond to transitions between a vehicle continuing along a straight path or turning. When the vehicle is turning, the transition to state S2 is based on whether the amount of turning has accumulated into a large enough angle or has turned far enough to be considered a large angle. For instance, a large angle threshold may be set at one hundred-twenty (120) degrees, and if not accumulated to this amount, the turning loop of state S1 continues (as reflected by the turning loop onto itself). In other words, the turning loop onto itself (S1) indicates a turn that does not rise to the level or threshold of a large angle. When the accumulated angle is large enough (e.g., to a preset threshold level or based on other indications), the state machine transitions to the S2 state.

In the S2 state, the state machine determines whether, even though in a large turn mode, the turn is a hard or sharp turn. The !HardTurn indicates that the turn is not a hard turn (and if not a hard turn, the state machine remains in the not hard turn mode), and the !FastTurn indicates that the vehicle is not making a fast turn (if the vehicle turn is not fast, the machine state remains in the not fast mode). In one embodiment, a fast turn may relate to an average turning speed of the entire turning process, whereas a sharp/hard turn may relate to travel speed during a later phase of the turning process. The thresholds may be set (e.g., based on historical data, testing, vehicle and/or terrain parameters, etc.) accordingly to categorize a turning process as falling into one, both or neither the fast and sharp/hard turn types. If the vehicle is not making a hard turn, and not making a fast turn, then then the state machine transitions to a watch state S2′ or large-turn keep mode. For instance, during a large turn, the operator may pause the vehicle, and then continue, such as to participate in another task or as a precaution before proceeding. The angle accumulation stops, but the turn has not ended yet, and thus instead of returning to S0 or S1, the state machine remains at the S2′ or large-turn keep mode.

The state machine may remain in the S2′ state until there is a time out (e.g., ImuSharpTurnKepTimeexpired). For instance, when the time out arrives, and the operator is still driving very slowly, then there is an assumption that the operator does not need the extended protection since the operator is cautious. Accordingly, the state machine exits to the turning mode (monitoring state transitions between S0 and S1). On the other hand, if the operator begins to turn fast while in the large turning mode, then the state machine proceeds to the S2 mode and determines whether the operator is maneuvering the vehicle in a hard turn or not.

Returning again to the S2 state, if the angle becomes very sharp (e.g., in the latter portion of the large turn), then the state machine transitions to the S3 state. For instance, the state machine may determine whether the turn is sharp or not using the last, say, 20% of the current turn, and based on the turn being within a certain amount of time and within a certain distance, the turn is considered sharp. For instance, and as explained above, if the time for the vehicle to make a ninety-degree turn is one minute, the turn is a large turn, though not a sharp turn. On the other hand, if the 90 degree turn is achieved in, say, five seconds, then it may be considered a sharp turn, which causes the extended detection zone to be deployed.

The S3′ state (the so-called sharp-turn keep mode) is analogous to the S2′ state—i.e., it is a watching or suspended state. For instance, once in an S3 turn (middle of a sharp or hard turn), the operator may cause the vehicle to slow down, giving rise to the S3′ state that provides the operator with an ability to observe and/or take precautions while still in the sharp turn.

Sensor input may be used to perform computations (e.g., by an inertial measurement unit), and the computations are in turn used by a controller to make predictions of sharp turns. The following equations or formulas are set forth below and identified with the various states from the state machine depicted by the state diagram 36 in FIG. 6.

### Turning:

MA25(angular-speed)≥ImuTurnSpeedThreshold (Eq. 1)

### FastTurn:

Average Angle≥ImuSharpTurnAverageAngleSpeedThreshold (Eq. 2)

### LargeAngle:

(Accumulated Angle≥ImuSharpTurnAngleThreshold)) (Eq. 3a)

Without the FastTurn predicate, a vehicle making a sharp turn at a very slow turning speed (!FastTurn) may enter the LargeAngle state prematurely, then after keep time goes back to the Turning state, which resets the Accumulated Angle.

Alternatively, Eq. 3b, immediately below, may be used:

(Accumulated Angle≥ImuTurnAngleDeterminateSharpThreshold)

The operator may not see the blind spot regardless of turning speed. This condition gives a vehicle making a sharp turn at a very slow turning speed a window of ImuSharpTurnKeepTime seconds to detect an object with an extended detection zone after reaching ImuTurnAngleDeterminateSharpThreshold.

HardTurn (Eq. 4 immediately below):

Traveling distance during last {ImuSharpTurnAngleThreshold−CalculateTurnDistanceStartAngle} degrees<SharpturnNeedToLowerDistance

SharpTurnNeedToLowerThanDistance>2.5*30*Pi*(ImuSharpTurnAngleThreshold−CalculateTurnDistanceStartAngle)/360 for CAT-775.

In a filtering step, the distance traveled between CalculateTurnDistanceStartAngle and ImuSharpTurnAngleThreshold is compared to SharpTurnNeedToLowerThanDistance to determine whether the turn is a sharp turn (true positive) or simply a large turn (false positive).

SlowTurn OR (!HardTurn) (Eq. 5)

SharpTurnMode may be S3 or S3′.

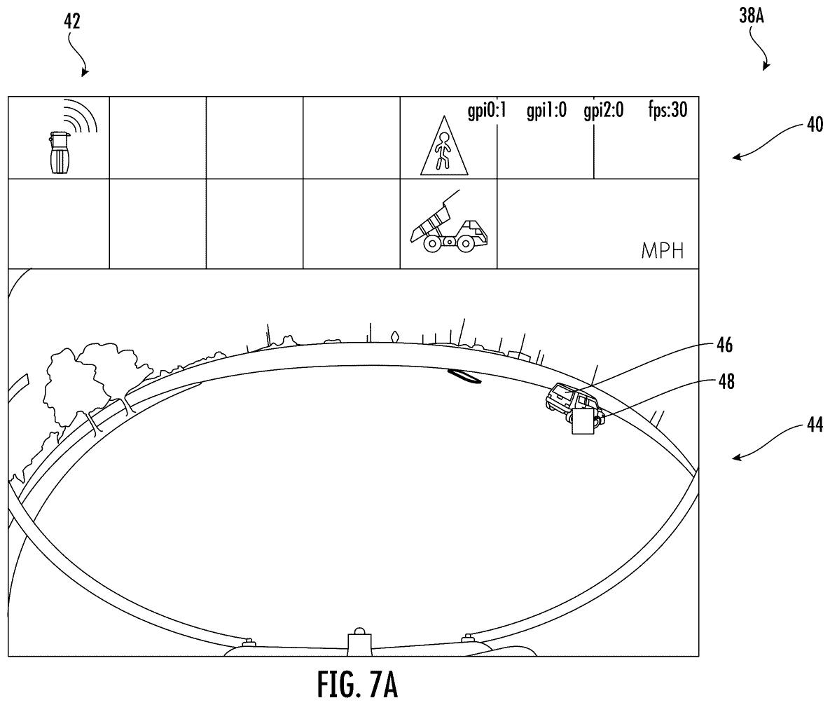

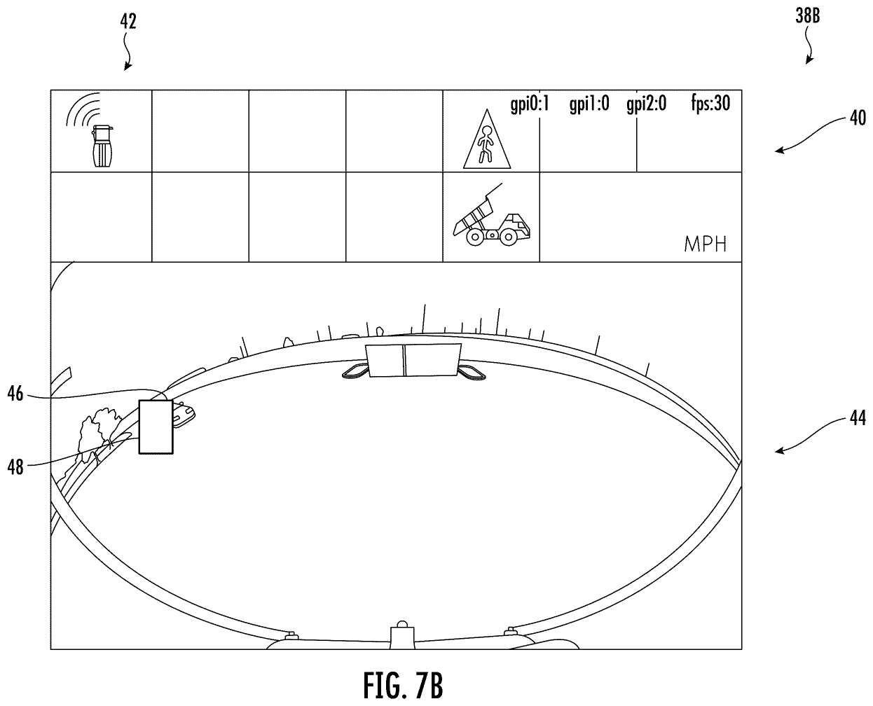

Attention is now directed to operator feedback mechanisms used by certain embodiments of a blind spot detection system when entering and in a sharp turn. Referring to FIG. 7A, shown is an example user interface 38A that illustrates an example camera view of an extended detection zone for a vehicle and detection of an obstruction at the right side of the vehicle for a right sharp turn for an embodiment of a blind spot detection system. The user interface 38A may be presented on a tablet device, phone, or in an on-board panel or screen of the vehicle 10. The user interface 38A comprises a symbol or icon section 40 that presents icons/symbols suggestive to the operator of different information. For instance, the symbol section 40 shows an icon 42 that suggests activation of the extended detection zone (e.g., coincident with entering and remaining in a sharp turn mode), and in which direction. In this example, the icon 42 depicts a schematic of a vehicle in overhead view with arc lines representing electromagnetic waves emanating from the vehicle and to the right to indicate the direction of the turn and extended detection zone. It should be appreciated that other symbols may be used to alert the operator to activation of the extended detection zone and/or direction. In some embodiments, feedback may take other forms (e.g., lights on a panel) or be omitted. The user interface 38A further comprises a camera screen 44, which shows in an approximately one hundred eighty (180) degree view a front and front-turning side view (e.g., to the right in FIG. 7A, or the extended detection zone). In some embodiments, the view may include a view of the side to side-rear view of the vehicle. An object 46 detected by the blind spot detection system is also shown in the extended detection zone. In some embodiments, the user interface 38A may present an alert to the operator of the presence of the object 46. Alert mechanisms may include audible alarms (verbal warnings or sounds, like beeping noise, etc.), tactile (e.g., vibration on the steering wheel), and/or visual. For instance, object 46 may be marked in a manner that heightens awareness to the operator, such as via a colored (e.g., red) symbol 48 overlaid onto the object 46 as shown, or actual coloring of the object, or other mechanisms to visually distinguish or alert the operator to the presence of the object 46. In some embodiments, the camera view switches between a rearward view of the vehicle 10 (e.g., used during non-sharp turn events) and the depicted front and front-turning side view when the vehicle 10 is in a sharp turn. In some embodiments, the camera view 44 may include front, side, and rear extended views of the extended detection zone.

As another example, FIG. 7B shows an example user interface 38B that illustrates an example camera view of an extended detection zone for a vehicle and detection of an obstruction at the left side of the vehicle for a left sharp turn for an embodiment of a blind spot detection system. Similar to the user interface 38A of FIG. 7A, the user interface 38B comprises a symbol or icon section 40 that shows an icon 42 that suggests activation of the extended detection zone (e.g., coincident with a sharp turn mode), and in which direction. In this example, the icon 42 depicts a schematic of a vehicle in overhead view with arc lines representing electromagnetic waves emanating from the vehicle and to the left to indicate the direction of the turn and extended detection zone, though other symbols may be used to alert the operator to activation of the extended detection zone and/or direction. The user interface 38B further comprises a camera screen 44, which shows in an approximately one hundred eighty (180) degree view a front and front-turning side view (e.g., to the left in FIG. 7B included in the extended detection zone), though as similarly described above, additional extended views (e.g., rearward) may also be shown. An object 46 detected by the blind spot detection system is also shown in the extended detection zone. As similarly described above, the user interface 38B may present an alert to the operator of the presence of the object 46. Alert mechanisms may include audible alarms (verbal or sounds, like beeping noise, etc.), tactile (e.g., vibration on the steering wheel), and/or visual. For instance, object 46 may be marked in a manner that heightens awareness to the operator, such as via a colored (e.g., red) symbol 48 overlaid onto the object 42 as shown, or actual coloring of the object, or other mechanisms to visually distinguish or alert the operator to the presence of the object 46.

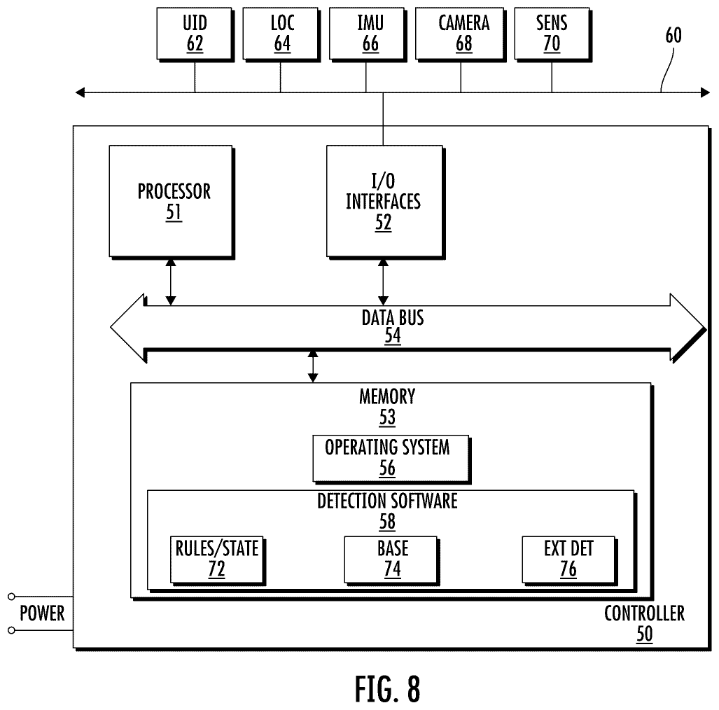

FIG. 8 is a schematic diagram that illustrates an embodiment of an example controller 50 used to carry out certain functionality of a blind spot detection system. In some embodiments, all or a portion of the components shown in FIG. 8 may embody the blind spot detection system. Note that though emphasis in this disclosure is on the use of a single controller, in some embodiments, functionality of the blind spot detection system may be achieved through the use of plural controllers. One having ordinary skill in the art should appreciate in the context of the present disclosure that the example controller 50 is merely illustrative, and that some embodiments of the controller 50 may comprise fewer or additional components, and/or some of the functionality associated with the various components depicted in FIG. 8 may be combined, or further distributed among additional modules, in some embodiments. In some embodiments, functionality of the controller 50 may be implemented according to other types of devices, including a programmable logic controller (PLC), FPGA device, ASIC device, among other devices. It should be appreciated that certain well-known components of computer devices are omitted here to avoid obfuscating relevant features of the controller 50.

In one embodiment, the controller 50 comprises one or more processors, such as processor 51, input/output (I/O) interface(s) 52, and memory 53, all coupled to one or more data busses, such as data bus 54.

The memory 53 may include any one or a combination of volatile memory elements (e.g., random-access memory RAM, such as DRAM, and SRAM, etc.) and nonvolatile memory elements (e.g., ROM, hard drive, tape, CDROM, etc.). The memory 53 may store a native operating system, one or more native applications, emulation systems, or emulated applications for any of a variety of operating systems and/or emulated hardware platforms, emulated operating systems, etc. In the embodiment depicted in FIG. 8, the memory 53 comprises an operating system 56 and blind spot detection software 58. It should be appreciated by one having ordinary skill in the art that in some embodiments, additional or fewer software modules (e.g., combined functionality) may be employed in the memory 53 or additional memory. In some embodiments, a separate storage device may be coupled to the data bus 54, such as a persistent memory (e.g., optical, magnetic, and/or semiconductor memory and associated drives).

The processor 51 may be embodied as a custom-made or commercially available processor, a central processing unit (CPU) or an auxiliary processor among several processors, a semiconductor based microprocessor (in the form of a microchip), a macroprocessor, one or more application specific integrated circuits (ASICs), a plurality of suitably configured digital logic gates, and/or other existing electrical configurations comprising discrete elements both individually and in various combinations to coordinate the overall operation of the controller 50.

The I/O interfaces 52 provide one or more interfaces to a network comprising a communication medium 60, which may be a wired medium (e.g., controller area network (CAN) bus) as depicted in FIG. 8, a wireless medium (e.g., Bluetooth channel(s)), or a combination of wired and wireless mediums. In other words, the I/O interfaces 52 may comprise any number of interfaces for the input and output of signals (e.g., analog or digital data) for conveyance over one or more communication mediums. In the depicted embodiment, a user interface device(s) (UID) 62, location device 64, an inertial measurement unit (IMU) 66, image acquisition device or camera (also, camera sensor) 68, and additional sensors (e.g., radar, lidar, steering wheel angle sensors, etc.) 70 are coupled to the communication medium 60, enabling communication of signals/data with the controller 50 via the I/O interfaces 52. Additional components may be coupled to the communication medium 60, including actuators (e.g., solenoids, motor controls, etc.) and/or telephony/radio components (e.g., cellular and/or radio frequency (RF) modem), enabling communications with the controller 50.

The user interface device(s) 62 may include a keyboard, mouse, microphone, touch-type display device, head-set, smart phone, tablet, and/or other devices (e.g., switches) that enable input by an operator and/or feedback to the operator (e.g., presentation or display of the user interfaces 38A and 38B of FIGS. 7A and 7B, audible sounds, lights (e.g., LEDs), tactile devices, etc.). In one embodiment, base settings for a detection zone may be stored in a table in memory for various conditions (e.g., vehicle speed, pitch, weather conditions, lighting, etc.) and chosen by the controller 50 based on sensor input.

The location device 64 may include a global navigation satellite system (GNSS), including global positioning system (GPS), or the like, providing location, distance traveled, speed, etc.

The inertial measurement unit 66 comprises existing technology, including accelerometer(s), gyroscope(s), and other circuitry to compute angular speed, pitch, roll, yaw, speed (e.g., based on accumulated acceleration over time), vehicle acceleration, and relative positioning relative of the vehicle.

The image acquisition device (camera) 68 may include a camera for providing visualization to the operator of detection zones and objects within the detection zones.

The sensors 70 may include additional sensors used in the navigation and/or sensing for the vehicle, including radar, lidar, acoustic sensors, steering wheel angle sensors, etc.

The blind spot detection software 58 comprises executable code/instructions that, when executed by the processor 51, receives input from the location device 64, inertial measurement unit 66, camera 68, and sensors 70, and predicts/detects a sharp turn and adjusts a detection zone (determined according to base settings) to an extended detection zone or range. The blind spot detection software 58 may present feedback of the detection zone, including any detected objects and camera views, on the user interface device 62 via a user interface with alerts and views (e.g., user interfaces 38A, 38B of FIGS. 7A, 7B). The blind spot detection software 58 may include image recognition software and radar processing software used in conjunction with the camera and radar (also herein, radar sensor), respectively. In one embodiment, the blind spot detection software 58 uses knowledge-based, heuristics to make predictions (e.g., as opposed to neural networks, where the existing accuracies of less than 100% are not ideal for applications where safety is a priority). For instance, for prediction, the blind spot detection software 58 comprises a rules/state machine module 72 to determine when the vehicle is entering and in a sharp turn (e.g., sharp turn mode), among the determination of other states and computation of equations as described above in association with FIG. 6. As explained above, functionality of the state machine may be replaced by a rules based decision making process. Data input for prediction includes sensor data (e.g., from the location device 64 and/or inertial measurement unit 66), and in some embodiments, may include additional sensor input including steering wheel sensors and/or radar sensors, etc. As to the adjustment of the detection zone to an extended detection zone, the blind spot detection software 58 further comprises base settings 74 of the vehicle detection zone, which may be a fixed setting for dimensions of a base detection zone. The blind spot detection software 58 further comprises a target or extended detection zone module 76, which may include a fixed setting for dimensions of the extended detection zone. In some embodiments, the base and extended settings 74, 76 may be variable dependent on various sensed conditions and/or vehicle dimensions (e.g., based on detected speed of the vehicle, threshold turning angle, and other sensor data including slope of the terrain upon which the vehicle is traveling, darkness (from sensed data), weather (e.g., fog, rain, etc.) from a barometer or via communication with a weather channel).

Execution of the blind spot detection software 58 is implemented by the processor 51 under the management and/or control of the operating system 56. In some embodiments, the operating system 56 may be omitted and a more rudimentary manner of control implemented.

In some embodiments, functionality of the blind spot detection software 58 may be distributed among plural controllers (and hence, plural processors). For instance, each controller may be similarly configured in hardware and/or software (e.g., one or more processors, memory comprising executable code/instructions, etc.) as the controller 50, with the control strategy including a peer-to-peer or primary-secondary control arrangement.

When certain embodiments of the controller 50 are implemented at least in part with software (including firmware), as depicted in FIG. 8, it should be noted that the software can be stored on a variety of non-transitory computer-readable medium for use by, or in connection with, a variety of computer-related systems or methods. In the context of this document, a computer-readable medium may comprise an electronic, magnetic, optical, or other physical device or apparatus that may contain or store a computer program (e.g., executable code or instructions) for use by or in connection with a computer-related system or method.

The software may be embedded in a variety of computer-readable mediums for use by, or in connection with, an instruction execution system, apparatus, or device, such as a computer-based system, processor-containing system, or other system that can fetch the instructions from the instruction execution system, apparatus, or device and execute the instructions.

When certain embodiments of the controller 50 are implemented at least in part with hardware, such functionality may be implemented with any or a combination of the following technologies, which are all well-known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

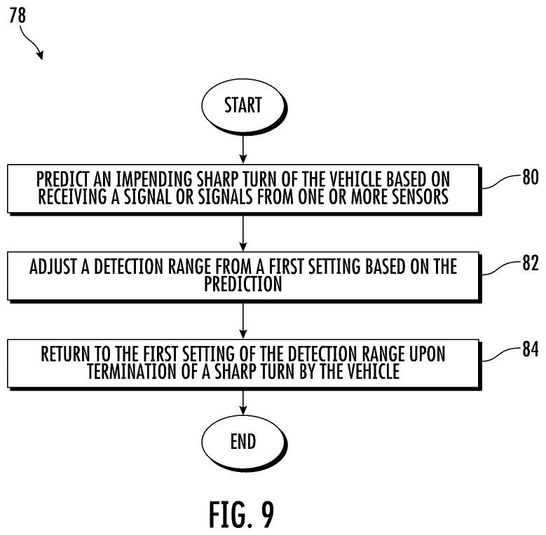

In view of the above description, it should be appreciated within the context of the present disclosure that one embodiment of an example blind spot detection method, denoted as method 78 (e.g., as implemented at least in part by the blind spot detection software 58, FIG. 8) and illustrated in FIG. 9, comprises predicting an impending sharp turn of the vehicle based on receiving a signal or signals from one or more sensors (80), adjusting a detection range from a first setting based on the prediction (82); and returning to the first setting of the detection range upon termination of a sharp turn by the vehicle (84).

Any process descriptions or blocks in flow diagrams should be understood as representing modules, segments, or portions of code which include one or more executable instructions for implementing specific logical functions or steps in the process, and alternate implementations are included within the scope of the embodiments in which functions may be executed out of order from that shown or discussed, including substantially concurrently or in reverse order, depending on the functionality involved, as would be understood by those reasonably skilled in the art of the present disclosure.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein. Although the control systems and methods have been described with reference to the example embodiments illustrated in the attached drawing figures, it is noted that equivalents may be employed and substitutions made herein without departing from the scope of the disclosure as protected by the following claims.

At least the following is claimed:

1. A blind spot detection system for a vehicle, the system comprising:
one or more sensors configured to detect vehicle movements;
a memory comprising instructions; and
a controller configured by the instructions to:
predict an impending sharp turn of the vehicle based on receiving a signal or signals from the one or more sensors;
adjust a detection range from a first setting based on the prediction; and
return to the first setting of the detection range upon termination of a sharp turn by the vehicle.

2. The system of claim 1, wherein the controller is configured by the instructions to predict by determining whether the vehicle is in a large angle turn or not.

3. The system of claim 2, wherein the controller is configured by the instructions to predict by determining, while the vehicle is in a large angle turn, whether the large angle turn is entering a sharp turn.

4. The system of claim 1, wherein the one or more sensors includes an inertial sensor.

5. The system of claim 1, wherein the controller is further configured by the instructions to predict based on a plurality of conditions and implementation of one of rules or a state machine.

6. The system of claim 5, wherein the controller is further configured by the instructions to predict based on computing sensor data from the one or more sensors.

7. The system of claim 1, wherein the controller is further configured by the instructions to adjust the detection range by extending the detection range according to a second setting.

8. The system of claim 7, wherein the controller is further configured by the instructions to extend the detection range on at least a turning side of the vehicle.

9. The system of claim 1, wherein the one or more sensors includes a radar sensor configured for detection of a zone along a turning side of the vehicle, wherein the controller is further configured by the instructions to use the radar sensor in a non-extended range or disable the radar sensor during a sharp turn of the vehicle.

10. The system of claim 1, wherein the controller is further configured by the instructions to return to the first setting of the detection range based on reaching a timeout.

11. The system of claim 1, wherein the controller is further configured by the instructions to return to the first setting of the detection range based on computing sensor data from the one or more sensors.

12. The system of claim 1, further comprising a user interface, wherein the controller is further configured by the instructions to indicate to an operator of the vehicle via the user interface the adjusted detection range.

13. The system of claim 12, wherein the controller is further configured by the instructions to present an alert, at the user interface, of a presence of an object in an area corresponding to the adjusted detection range.

14. The system of claim 13, wherein the controller is further configured by the instructions to visually mark the object in the user interface.

15. The system of claim 12, wherein the one or more sensors further comprises a camera, wherein the controller is further configured by the instructions to adjust a camera view presented on the user interface from a rear view to a view covering the adjusted detection range based on the adjustment of the detection range.

16. A blind spot detection method for a vehicle, the method comprising:
predicting an impending sharp turn of the vehicle based on receiving a signal or signals from one or more sensors;
adjusting a detection range from a first setting based on the prediction; and
returning to the first setting of the detection range upon termination of a sharp turn by the vehicle.

17. The method of claim 16, wherein the adjusting comprises extending the detection range on a turning side of the vehicle.

18. The method of claim 16, further comprising determining whether the vehicle is in a large angle turn or not.

19. The method of claim 18, further comprising determining, while the vehicle is in a large angle turn, whether the large angle turn is entering a sharp turn.

20. A non-transitory, computer readable storage medium comprising instructions that, when executed by a controller, causes the controller to:
predict an impending sharp turn of the vehicle based on receiving a signal or signals from one or more sensors;
adjust a detection range from a first setting based on the prediction; and
return to the first setting of the detection range upon termination of a sharp turn by the vehicle.
